(19) United States
(12) Patent Application Publication
(10) Pub. No.: US 2004/0114795 A1
(43) Pub. Date: Jun. 17, 2004

(54) Method and apparatus for color processing

(76) Inventors: Chung-Yen Lu, Taipei City (TW); Hung-Ju Huang, Hsinchu City (TW)

Correspondence Address: SUPREME PATENT SERVICES, POST OFFICE BOX 2339, SARATOGA, CA, 95070, US

(21) Appl. No.: 10/318,750

(22) Filed: Dec. 12, 2002

(51) Int. Cl. G06K 9/00

(52) U.S. Cl. 382/162

(57) ABSTRACT

A color processing method enhances color intensity and saturation in RGB domain. For a pixel to be enhanced, a new set of color values, (R′,G′,B′), are computed base on its original color values, (R,G,B). The original red, green, and blue intensity values are used to obtain a scaling factor and an intensity base. The scaling factor is then compared with a user controlled scaling factor to obtain a final scaling factor. The new set of color values are computed based on the final scaling factor and the intensity base to enhance the intensity and saturation of the pixel.

### FIELD OF THE INVENTION

This invention relates to computer graphics and image processing, and more specifically to a method and an apparatus for color processing used in computer graphics and image processing.

### BACKGROUND OF THE INVENTION

Computer monitors, from whichever manufactures, usually show a nonlinear relationship between pixel values and intensity. Because of this hardware characteristic, an image usually appears darker than its original pixel values specified when the image is displayed on the monitor. To correct this problem, various techniques are developed to enhance the color intensity.

Conventional color processing methods enhance red, green, and blue intensities individually. For example, a new red intensity of a pixel is determined according to its original red intensity. Similarly, a new green intensity of the pixel is determined according to its original green intensity, and a new blue intensity of the pixel is determined according to its original blue intensity. As an example, the gamma correction, a well-known method for color processing, improves each color channel by the channel intensity itself based on a non-linear curve. For instance, gamma correction for the red channel may be expressed as:

Rᵢ′=kRᵢ^{1/γ}ᵣ,

where Rᵢ is the input red intensity, Rᵢ′ is the red intensity after the gamma correction, k is a constant, and γᵣ is the gamma factor for the red channel. As seen in FIG. 1, the gamma correction leaves zero and maximum intensities unchanged and alters the intensity in the mid-range. Similar gamma correction is then performed for the green and blue channels, respectively.

Another conventional method for color processing adopts a simplified mathematical form to perform a similar effect as gamma correction. For example, the new intensity of the red channel could be computed as follows:

Rᵢ′=2Rᵢ−Rᵢ²,

where Rᵢ is the normalized input intensity between 0 and 1, and Rᵢ′ is the adjusted red intensity, which also falls into the range between 0 and 1. In practice, if the red intensity is represented with 8 bits, that is, the red intensity is between 0 to 255, the new intensity should be computed as:

Rᵢ′=Rᵢ(2−Rᵢ/255),

where both Rᵢ and Rᵢ′ are represented with 8 bits.

The conventional color processing has a potential problem of non-uniform enhancement because the intensities of red, green and blue are processed individually. This is caused by the fact that the aforementioned methods may use different gamma values when the respective red, green, and blue channels are corrected. In this case, the image displayed on the computer monitor may appear to be unnatural in color.

### SUMMARY OF THE INVENTION

The present invention has been made to overcome the above mentioned problem of non-uniform enhancement in color processing. A new color processing method and an apparatus for enhancing color intensity and saturation in RGB domain are provided.

In the present invention, the original red, green, and blue intensity values are used to obtain a scaling factor. The scaling factor is then compared with a user controlled scaling factor to obtain a final scaling factor. An intensity base is also computed based on the original red, green, and blue intensity values. The final scaling factor and the intensity base are then used to compute the new intensity values of all three color channels.

The invention also provides an apparatus for the color processing. Accordingly, the apparatus comprises a SORT block for determining the maximum and minimum values of the input R, G and B values of a pixel. A SCALE DECISION block determines a final scaling factor based on the maximum and minimum values and a user controlled scaling factor. A BASE DECISION block uses the maximum and minimum values to compute an Ibase value. The following color processing is divided into three stages including a DIFFERENCE step, a SCALING step and an OFFSET step to compute the enhanced intensity values for the pixel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a diagram that shows the intensity changes with a method of prior arts.

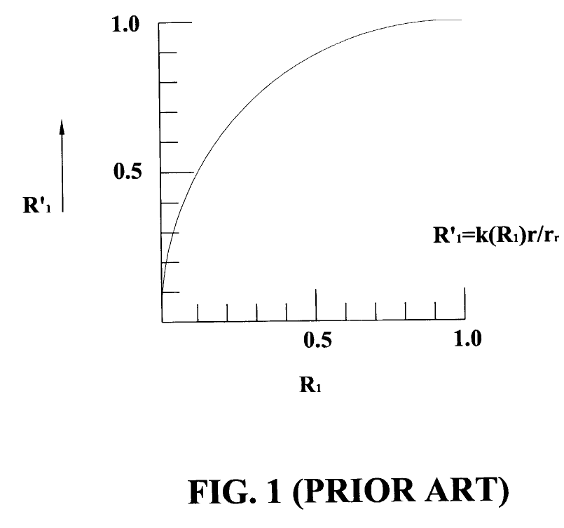

FIG. 2 is a diagram that shows the flowchart of the present invention.

FIG. 3 is a diagram that shows the structure of the apparatus of the present invention.

FIG. 4 shows a preferred embodiment of the present invention.

FIG. 5 shows the structure of the apparatus of the preferred embodiment in FIG. 4.

### DETAILED DESCRIPTION OF THE PREFERRED EMBODIMENTS

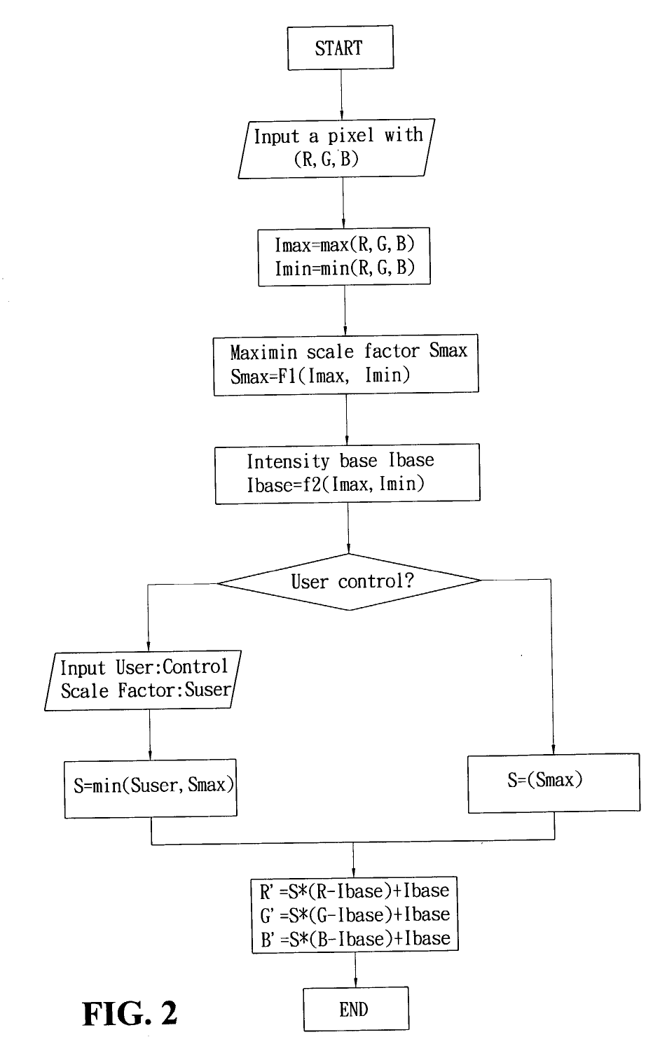

The flowchart of the present invention is illustrated in FIG. 2. Let R, G, B represent the intensity of red, green and blue channels of a pixel. For a pixel to be enhanced, its (R,G,B) values are to be processed. After obtaining the (R,G,B) values, the maximum and minimum of the R, G, B values are computed and denoted as Imax and Imin, where Imax=max (R,G,B) is the maximum value of R, G, and B, and Imin=min(R,G,B) is the minimum value of R, G, and B.

The next step is to compute the maximum scaling factor Smax which is defined as a function of variables Imax and Imin, that is, Smax=f1(Imax, Imin). The intensity base Ibase, which is also defined as a function of the variables Imax and Imin, is computed and denoted as Ibase=f2(Imax, Imin) as well.

The following step is to determine a final scaling factor based on the maximum scaling factor and a scaling factor controlled by a user. If the user controlled scaling factor Suser is present, the final scaling factor is set to be the smaller value of the maximum scaling factor and the controlled scaling factor, i.e., S=min(Smax, Suser). Otherwise, the final scaling factor is set to be the maximum scaling factor, i.e., S=Smax.

The actual color enhancement process comprises the computation of the new (R,G,B) intensity values of the pixel. The color enhancement procedure uses the two parameters, S and Ibase, to compute the enhanced intensity values (R′,G′,B′) based on the original (R,G,B) values. The computation uses the following equation:

R′=S*(R−Ibase)+Ibase,

G′=S*(G−Ibase)+Ibase,

B′=S*(B−Ibase)+Ibase.

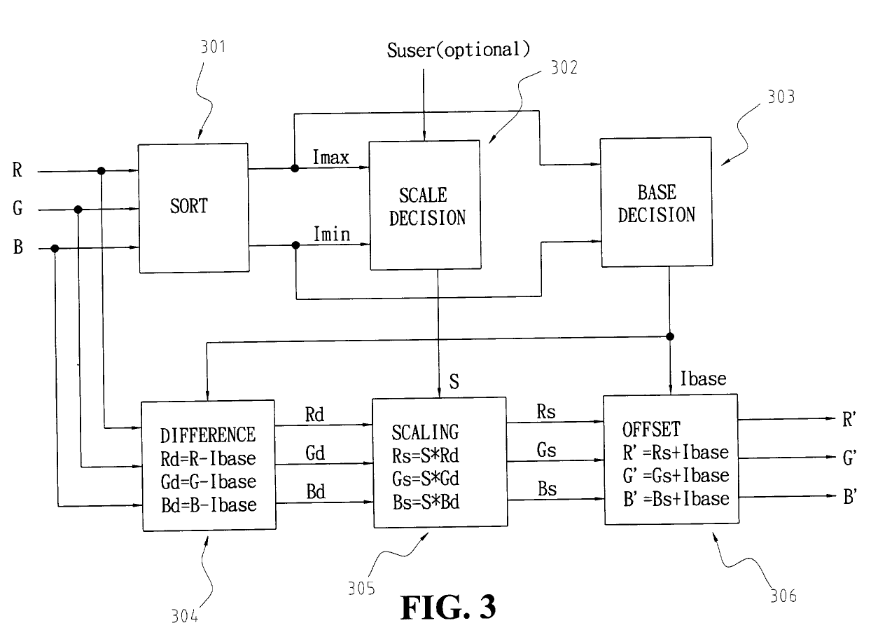

An apparatus for performing the color processing according to the present invention is illustrated in FIG. 3. The SORT block 301 reads the original R, G, B values of a pixel, and outputs the maximum and minimum values, Imax and Imin, of the input R, G, B values. The SCALE DECISION block 302 accepts an optional user controlled scaling factor which is entered by the user. The Imax and Imin values computed by the SORT block 301 are also sent to the SCALE DECISION block 302 for determining a final scaling factor S. The BASE DECISION block 303 uses the Imax and Imin values to compute an Ibase value.

The color enhancement process of this invention relies on the S and Ibase values computed above. It can be divided into DIFFERENCE 304, SCALING 305 and OFFSET 306 steps. The computation in DIFFERENCE 304 is to compute the difference between the original intensity values of a pixel and the computed Ibase value as the following:

Rd=R−Ibase,

Gd=G−Ibase, and

Bd=B−Ibase.

The computation in SCALING 305 is to scale the output generated by DIFFERENCE 305 as the following:

Rs=S*Rd,

Gs=S*Gd, and

Bs=S*Bd.

And the final step OFFSET 306 is to adjust the computed scaled value by the Ibase value as the following:

R′=Rs+Ibase,

G′=Gs+Ibase, and

B′=Bs+Ibase.

The final output (R′,G′,B′) is the enhanced values of the input pixel.

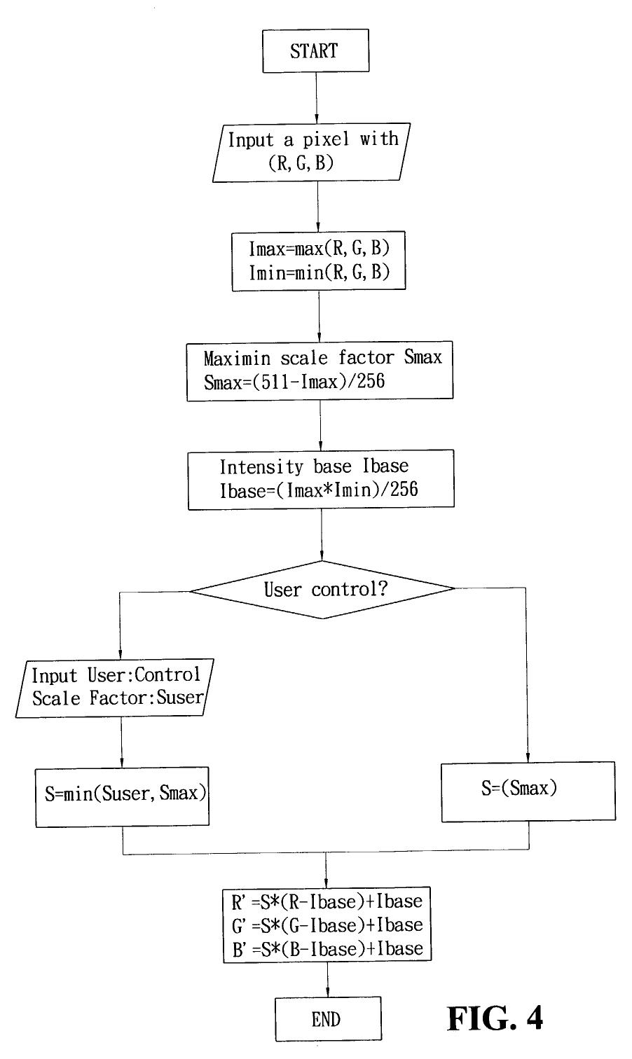

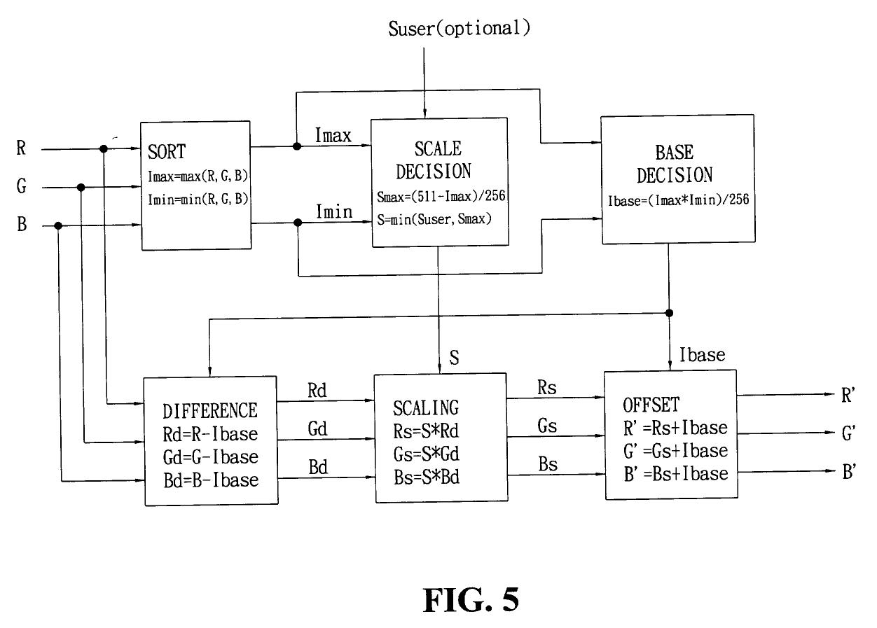

FIG. 4 shows the flowchart of a preferred embodiment of the present invention. In this embodiment, the scaling factor Smax is computed as a function of the variables Imax and Imin, namely, Smax=(511−Imax)/256. And the Ibase value is computed as a function of the variable Imax, and Imin, namely, Ibase=(Imax*Imin)/256. And FIG. 5 shows the devised apparatus in accordance with the preferred embodiment of FIG. 4.

As described earlier, the maximum scaling factor Smax and the intensity base Ibase are defined as functions of Imax and Imin. The preferred embodiment shown in FIG. 4 provides an example for each of them. Other possible functions that may be used in computing Smax, and Ibase effectively include but not limited to the following:

Smax=f1(Imax,Imin)=2−Imax/255,

Smax=f1(Imax,Imin)=(511−Imax)/256,

Smax=f1(Imax,Imin)=255/Imax,

Smax=f1(Imax,Imin)=(255−Imin)/(Imax−Imin),

Smax is a gamma correction curve,

Ibase=f2(Imax,Imin)=0,

Ibase=f2(Imax,Imin)=Imin,

Ibase=f2(Imax,Imin)=Imin*Imax/255.0, and

Ibase=f2(Imax,Imin)=Imin*Imax/256.0.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for color processing, comprising the steps of:
(a) reading (R,G,B) values of a pixel;
(b) computing Imax and Imin, said Imax and Imin being maximum and minimum values of said R, G and B values respectively;
(c) computing a maximum scaling factor Smax=f1(Imax, Imin), said f1 being a function of said Imax and Imin;
(d) computing an intensity base Ibase=f2(Imax, Imin), said f2 being a function of said Imax and Imin;
(e) reading an optional user controlled scaling factor Suser if said Suser is present;
(f) setting a final scaling factor S=min(Smax, Suser) as a minimum value between said Smax and said Suser if said Suser is present, or setting a final scaling factor S=Smax if said Suser is not present; and
(g) computing enhanced (R′,G′,B′) values of said pixel according to equations:
R′=S*(R−Ibase)+Ibase,
G′=S*(G−Ibase)+Ibase, and
B′=S*(B−Ibase)+Ibase.

2. The method for color processing as claimed in claim 1, wherein said function f1 is Smax=f1(Imax, Imin)=2−Imax/255.

3. The method for color processing as claimed in claim 1, wherein said function f1 is Smax=f1(Imax, Imin)=(511−Imax)/256.

4. The method for color processing as claimed in claim 1, wherein said function f1 is Smax=f1(Imax, Imin)=255/Imax.

5. The method for color processing as claimed in claim 1, wherein said function f1 is Smax=f1(Imax, Imin)=(255−Imin)/(Imax−Imin).

6. The method for color processing as claimed in claim 1, wherein said function f1 is Smax is a gamma correction curve.

7. The method for color processing as claimed in claim 1, wherein said function f2 is Ibase=f2(Imax, Imin)=0.

8. The method for color processing as claimed in claim 1, wherein said function f2 is Ibase=f2(Imax, Imin)=Imin.

9. The method for color processing as claimed in claim 1, wherein said function f2 is Ibase=f2(Imax, Imin)=Imin*Imax/255.0.

10. The method for color processing as claimed in claim 1, wherein said function f2 is Ibase=f2(Imax, Imin)=Imin*Imax/256.0.

11. An apparatus for color processing, comprising:
a SORT block for reading original R, G, B values of a pixel, and outputting Imax and Imin, said Imax and Imin being maximum and minimum values of said R, G, and B, values respectively;
a SCALE DECISION block for accepting an optional user controlled scaling factor Suser from a user, and determining a final scaling factor S=min(Smax, Suser) if said Suser is present or a final scaling factor S Smax if said Suser is not present, said Smax being a maximum scaling factor computed using said Imax and Imin according to Smax=f1(Imax, Imin), and said f1 being a function of said Imax and Imin;
a BASE DECISION block for computing Ibase=f2(Imax, Imin), said f2 being a function of said Imax and Imin;
a DIFFERENCE block for computing a difference between said original intensity values (R,G,B) of said pixel and said Ibase according to:
Rd=R−Ibase,
Gd=G−Ibase, and
Bd=B−Ibase;
a SCALING block for scaling said Rd, Gd, Bd values generated by said DIFFERENCE block with said scaling factor S according to:
Rs=S*Rd,
Gs=S*Gd, and
Bs=S*Bd;
and an OFFSET block for adjusting said Rs, Gs, Bs values with said Ibase value according to:
R′=Rs+Ibase,
G′=Gs+Ibase, and
B′=Bs+Ibase;
wherein said (R′,G′,B′) are enhanced values of said pixel.

12. The apparatus for color processing as claimed in claim 11, wherein said function f1 is Smax=f1(Imax, Imin)=2−Imax/255.

13. The apparatus for color processing as claimed in claim 11, wherein said function f1 is Smax=f1(Imax,Imin)=(511−Imax)/256.

14. The apparatus for color processing as claimed in claim 11, wherein said function f1 is Smax=f1(Imax,Imin)=255/Imax.

15. The apparatus for color processing as claimed in claim 11, wherein said function f1 is Smax=f1 (Imax,Imin)=(255−Imin)/(Imax−Imin).

16. The apparatus for color processing as claimed in claim 11, wherein said function f1 is Smax is a gamma correction curve.

17. The apparatus for color processing as claimed in claim 11, wherein said function f2 is Ibase=f2(Imax,Imin)=0.

18. The apparatus for color processing as claimed in claim 11, wherein said function f2 is Ibase=f2(Imax,Imin)=Imin.

19. The apparatus for color processing as claimed in claim 11, wherein said function f2 is Ibase=f2(Imax,Imin)=Imin*Imax/255.0.

20. The apparatus for color processing as claimed in claim 11, wherein said function f2 is Ibase=f2(Imax,Imin)=Imin*Imax/256.0.
